(19) United States
(12) Patent Application Publication
(10) Pub. No.: US 2014/0103259 A1
(43) Pub. Date: Apr. 17, 2014

(54) MULTI-TUBULAR STEAM REFORMER AND PROCESS FOR CATALYTIC STEAM REFORMING OF A HYDROCARBONACEOUS FEEDSTOCK

(71) Applicant: Paul Adriaan Compagne, Delfzijl (NL)

(72) Inventor: Paul Adriaan Compagne, Delfzijl (NL)

(73) Assignee: BioMethanol CHemie Nederland B.V

(21) Appl. No.: 14/008,906

(22) PCT Filed: Apr. 4, 2012
(86) PCT No.: PCT/NL2012/050224

§ 371 Date: Nov. 25, 2013

(30) Foreign Application Priority Data
Apr. 7, 2011 (EP) 11161478.0
May 12, 2011 (EP) 11165913.2

(51) Int. Cl. C01B 3/26; B01J 8/06

(52) U.S. Cl. CPC C01B 3/26; B01J 8/067
USPC 252/373; 422/162

(57) ABSTRACT

A multi-tubular steam reformer is disclosed, which comprises a steam reforming zone heated by an external heat source and contains a plurality of parallel steam reforming tubes (each comprising a gas supply inlet); a fixed bed of steam reforming catalyst; and a solid, inert insert having an upstream end and a downstream end and is placed in the tube downstream of the gas supply inlet and upstream of the catalyst bed The insert has a tortuous free fluid flow path and the upstream end of the catalyst bed is adjacent to the downstream end of the insert. The ratio of the length of the insert and the length of the catalyst bed is in the range of from 0.05 to 0.5. The invention further relates to a process for catalytic steam reforming of a hydrocarbonaceous feedstock comprising an oxygenated hydrocarbonaceous compound in such multi-tubular steam reformer.

### FIELD OF THE INVENTION

The invention relates to a multi-tubular steam reformer and to a process for catalytic steam reforming of a hydrocarbonaceous feedstock comprising an oxygenated hydrocarbonaceous compound, preferably glycerol, in such multi-tubular steam reformer.

### BACKGROUND OF THE INVENTION

In an effort to mitigate carbon dioxide emissions, the European Union has issued directives that set a minimum to the amount of automotive fuel derived from biomass. As a result, the production of biodiesel is steadily increasing. The availability of crude glycerol, a by-product of the production of biodiesel from triglycerides, is increasing accordingly. It is therefore important to find useful applications for glycerol. One of the possible applications is the conversion of glycerol into synthesis gas by catalytic steam reforming. Synthesis gas can then be converted into chemical feedstock or chemical products such as for example hydrocarbons (Fischer-Tropsch hydrocarbon synthesis) or methanol.

Catalytic steam reforming of hydrocarbons such as natural gas or methane is a well-known process that proceeds according to the following equation:

CₙH₍₂ₙ₊₂₎+nH₂O [symbol] nCO+(2n+1)H₂ (1)

The steam reforming reaction is highly endothermic and is therefore typically carried out in an externally heated steam reforming reactor, usually a multi-tubular steam reformer comprising a plurality of parallel tubes placed in a furnace, each tube containing a fixed bed of steam reforming catalyst particles. The hydrocarbon feedstock is typically first pre-heated, usually against the flue gas of the furnace, before it is supplied to the catalyst filled tubes. Typically, the mixture of feedstock and steam that is supplied to the catalyst filled tubes has a temperature in the range of from 300 to 550° C. The catalyst bed is typically operated at an averaged bed temperature of 800-900° C.

Likewise, oxygenated hydrocarbonaceous compounds such as ethanol or glycerol can be converted into synthesis gas according to the following equation:

CₙHₘOₖ+(n−k)H₂O [symbol] nCO+(n+m/2−k)H₂ (2)

In WO2008/028670 and WO2009/112476, for example, catalytic steam reforming of glycerol is disclosed.

In catalytic stream reforming processes, fouling of the catalyst bed by coke formation is a major problem. Typically at temperatures above 400 or 450° C., carbon containing deposits are formed on metal catalysts in the presence of hydrocarbons and carbon monoxide. Such carbon deposits result in for example pressure drop problems, reduced activity by covering active catalyst sites. When oxygenated hydrocarbonaceous feedstocks are used, the coke formation problem is more pronounced, since oxygenated hydrocarbonaceous feedstocks such as ethanol or glycerol are more thermo-labile than hydrocarbons and therefore more prone to carbon formation.

In JP2009-298618 is disclosed a process for catalytic steam reforming of glycerol wherein used catalyst particles are continuously supplied to a burner to burn off the carbon deposits and then recycled to the steam reforming reactor. A disadvantage of the process of JP2009-298618 is that carbon deposition is not prevented and that thus a catalyst burner is needed. In JP2009-298615, carbon formation is minimised by introducing a mist-like glycerol/steam mixture into the steam reforming reactor.

### SUMMARY OF THE INVENTION

It has now been found that carbon deposition on steam reforming catalysts when using a feedstock comprising an oxygenated hydrocarbonaceous compound, can be prevented to a minimum by placing a solid, inert insert in each tube of a multi-tubular steam reformer, just upstream of the steam reforming catalyst. The insert is placed in the tube such that the feed gas mixture supplied to each tube is forced to flow through the insert. The insert has such a shape that a tortuous free fluid flow part is defined through the insert so that the effective length of the fluid flow path is longer than the length of the insert. The tortuous free fluid path thus provided results in turbulence in the feed mixture and thereby in improved heat transfer from the externally heated tube walls to the feed mixture.

Accordingly, the invention relates to a multi-tubular steam reformer comprising a steam reforming zone, wherein the steam reforming zone is heated by an external heat source and contains a plurality of parallel steam reforming tubes, wherein each tube comprises a gas supply inlet and contains a fixed bed of steam reforming catalyst and a solid, inert insert having an upstream end and a downstream end which insert is placed in the tube downstream of the gas supply inlet and upstream of the catalyst bed, wherein the insert is defining a tortuous free fluid flow path through the tube between the upstream end and the downstream end of the insert, and wherein the catalyst bed has an upstream end and a downstream end and wherein the downstream end of the insert is adjacent to the upstream end of the catalyst bed and wherein the ratio of the length of the insert and the length of the catalyst bed is in the range of from 0.05 to 0.5.

The multi-tubular steam reformer according to the invention provides for improved heat transfer between the feed supplied to the reforming tubes and the walls of the tubes upstream of the catalyst bed. Thus, the feed mixture is heated to a temperature of at least 600° C., before it contacts the steam reforming catalyst. It has surprisingly been found that oxygenated hydrocarbonaceous compounds such as glycerol cause less carbon deposits if the feedstock is contacted with the catalyst at temperatures of at least 600° C., preferably at least 650° C. In the present process in the present steam reformer, the feed mixture is heated relatively quickly to such temperature before it reaches the catalyst bed. It has been found that carbon deposition on the catalyst bed can thus be minimised.

Accordingly, the invention further relates to a process for catalytic steam reforming of a hydrocarbonaceous feedstock comprising an oxygenated hydrocarbonaceous compound, wherein, in a multi-tubular steam reformer as defined hereinabove, a gaseous feed mixture comprising the hydrocarbonaceous feedstock and steam and having a temperature in the range of from 300 to 550° C. is supplied to the gas supply inlet of each of the steam reforming tubes, flows through the insert and is subsequently contacted with the catalyst bed, wherein the feed mixture has a temperature of at least 600° C., preferably at least 650° C. when contacting the upstream end of the catalyst bed.

### SUMMARY OF THE DRAWINGS

FIGS. 1A to 1C show different non-limiting examples of inserts that can suitably be used in the tubes of the steam reformer according to the invention. In each of FIGS. 1A to 1C is shown a schematic drawing of a longitudinal section of the upstream part of a steam reforming tube comprising an insert.

### DETAILED DESCRIPTION OF THE INVENTION

The multi-tubular steam reformer according to the invention is heated by an external heat source in order to provide the heat needed for the endothermic steam reforming reaction. External heat sources for multi-tubular steam reformers are known in the art. Any suitable external heat source may be used, for example a furnace or one or more burners.

The steam reforming zone contains a plurality of parallel steam reforming tubes, each tube having a gas supply inlet, and each tube containing a fixed bed of steam reforming catalyst (catalyst bed) and a solid, inert insert. The insert is placed in the tube at a location downstream of the gas supply inlet and upstream of the catalyst bed. The insert has an upstream end and a downstream end and is defining, when placed in the tube, a tortuous free fluid flow path through the tube over the length of the insert, i.e. between the upstream end and the downstream end of the insert.

Upstream and downstream is defined herein with relation to the fluid flow during normal operation of the steam reformer.

The insert is preferably gas-tightly fitted into the tube so that fluid is forced to flow through the insert and essentially no fluid flow occurs between the insert and the tube wall.

Reference herein to a tortuous flow path is to a flow path that has an effective length that is greater than the length of the insert. Reference herein to the length of the insert is to the distance between upstream end and downstream end of the insert, i.e. the length of the insert in axial direction. Reference to the effective length of the fluid flow path is to the length of the flow path in the direction perpendicular to the flow direction.

Preferably, the effective length of the tortuous free fluid flow path is at least 1.5 times, more preferably at least 2.0 times, the length of the insert. Preferably, the effective length of the tortuous free fluid flow path is at most 10 times the length of the insert. A tortuous free fluid flow path having an effective length that is in the range of from 3.0 to 8.0 the length of the insert is particularly preferred.

During normal operation of the reactor, the tortuous free fluid flow path in the tube over the length of the insert creates turbulence in the gas feed supplied to the catalyst bed and thus improves heat transfer from the heated tube walls to the gas feed.

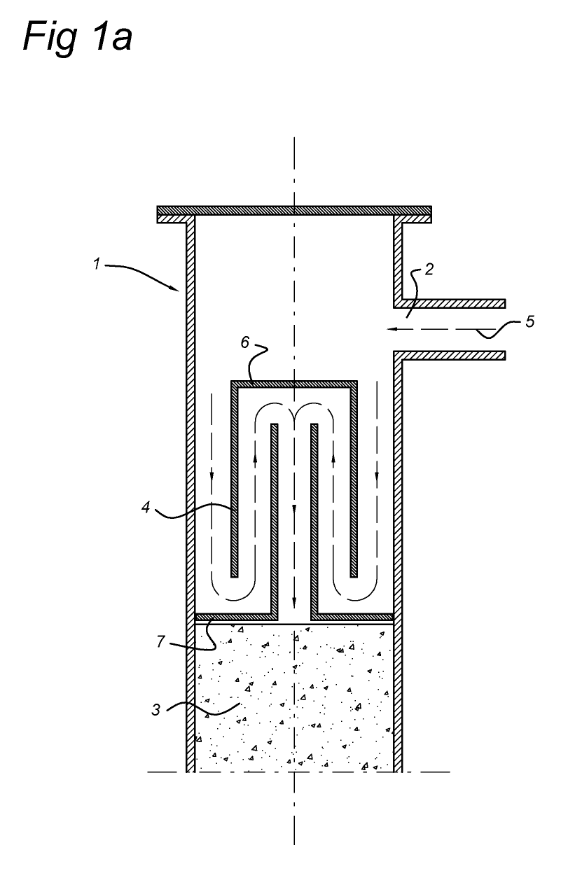

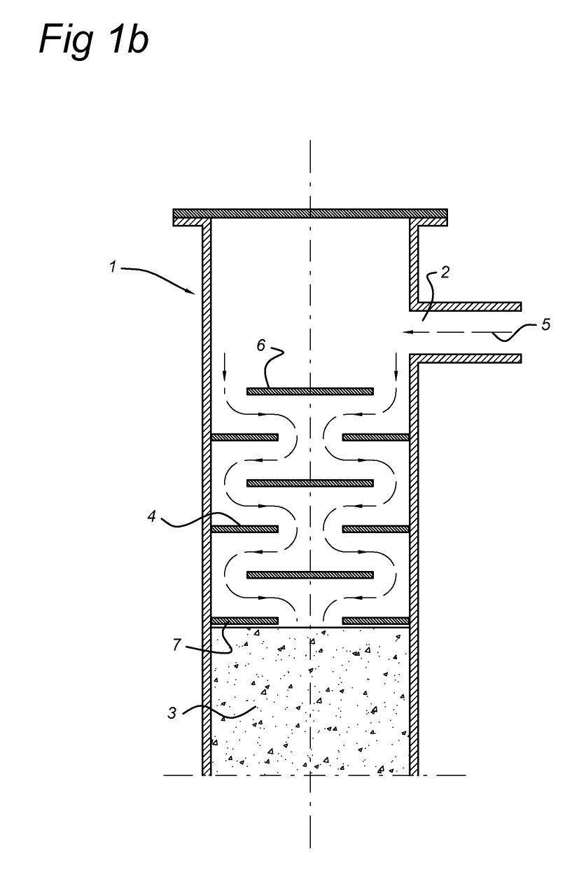

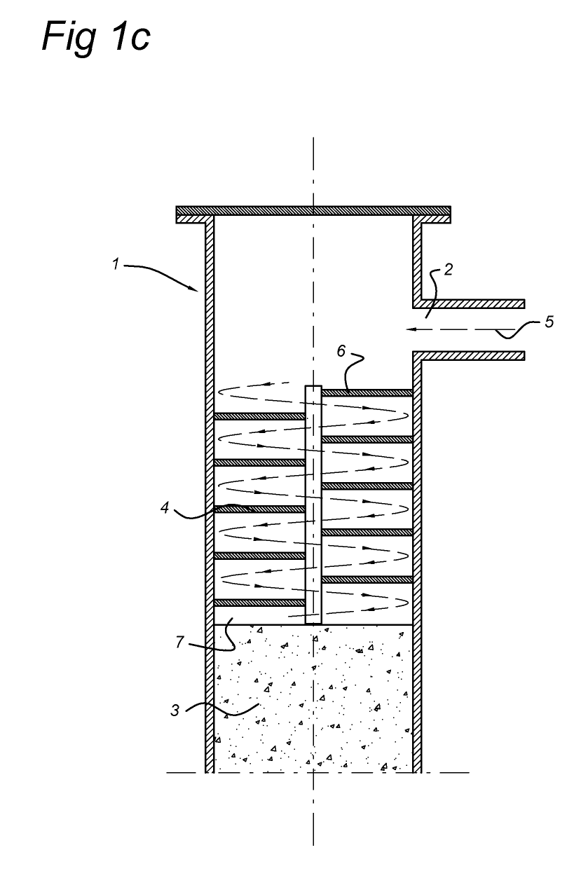

The shape of the insert is preferably such that, during normal operation of the reactor, the pressure drop over the insert is minimised. The pressure drop over the insert is preferably at most 20%, more preferably at most 10% of the total pressure drop over the insert and the catalyst bed. The pressure drop over the insert will usually be at least 1% of the total pressure drop over the insert and the catalyst bed. The insert may have any suitable shape that provides for a tortuous free fluid flow path to improve heat transfer whilst minimising pressure drop. Examples of suitable inserts are a bed of inert particles, a helically would insert defining a helical flow path. In FIGS. 1A to 1C, non-limiting examples of suitable inserts are shown. An insert defining a helical free fluid flow path, such as shown in FIG. 1C, is particularly preferred.

The length of the insert is at most 0.5 times the length of the catalyst bed, preferably at most 0.3 times. In order to achieve sufficient heat transfer from tube wall to feed mixture upstream of the catalyst bed, the length of the insert is at least 0.05 times, preferably at least 0.1 times, the length of the catalyst bed. The downstream end of the insert is adjacent to the upstream end of the catalyst bed. ‘Adjacent to’ means herein that insert and catalyst bed touch each other or are placed at a small distance from each other, typically in the order of a few centimeters for an insert and a catalyst bed each having a length in the order of metres.

The insert may be of any inert material that is resistant to temperatures of up to 900° C., preferably up to 1000° C. Examples of suitable materials are metals, including metal alloys, and ceramic materials. Examples of suitable ceramic materials are zirconia, silica, alumina, magnesia or materials comprising combinations thereof. Examples of suitable metals are stainless steel, fecralloy, or inconel. Any metal suitably used for steam reformer reactor tubes can also be suitably used for the insert. Particularly preferred metals are Ni—Cr steel alloy and inconel. Preferably, the insert is a metal insert.

Reference herein to an inert material is to any material that has no catalytic steam reforming activity under the conditions that may prevail in the upstream part of the reforming zone, i.e. typically a temperature in the range of from 300 to 900° C. and a pressure of in the range of from 1 to 50 bar (absolute).

In the process for catalytic steam reforming according to the invention, a gaseous feed mixture comprising a hydrocarbonaceous feedstock which comprises an oxygenated hydrocarbonaceous compound and steam is supplied to the gas supply inlet of each steam reforming tube. Reference herein to a hydrocarbonaceous feedstock is to a feedstock comprising one or more hydrocarbonaceous compounds, i.e. compound comprising hydrogen atoms and carbon atoms and optionally heteroatoms such as oxygen, sulphur or nitrogen. Oxygenated hydrocarbonaceous compounds are defined as molecules containing, apart from carbon and hydrogen atoms, at least one oxygen atom that is linked to either one or two carbon atoms or to a carbon atom and a hydrogen atom. Examples of suitable oxygenated hydrocarbonaceous compounds are ethanol, acetic acid, and glycerol. Glycerol is particularly preferred. Preferably, the hydrocarbonaceous feedstock comprises oxygenated hydrocarbonaceous compounds or a mixture of hydrocarbons and oxygenated hydrocarbonaceous compounds. Examples of suitable hydrocarbons are natural gas, biogas, methane, ethane, Liquefied Petroleum Gas (LPG), and propane. Preferably, the feedstock is glycerol or a mixture of glycerol with natural gas, biogas, methane or LPG. More preferably, the feedstock is glycerol, or a mixture of glycerol with natural gas, biogas or methane.

The weight ratio of hydrocarbon to oxygenated hydrocarbonaceous compound in the feedstock is preferably in the range of from 1:1 to 3:1.

The gaseous feed mixture comprises the hydrocarbonaceous feedstock and steam. Preferably, the molar steam to carbon ratio (molecules of steam to atoms of carbon) in the feed mixture is in the range of from 2.0 to 5.0, more preferably of from 2.5 to 4.0. Even more preferably, the molar steam to carbon ratio in the feed mixture is at most 3.5.

The feed mixture may comprise a molecular-oxygen containing gas such as for example air or oxygen. If the feed mixture contains a molecular-oxygen containing gas, it will contain such gas in a low amount, preferably the feed mixture contains at most 10 vol % molecular oxygen, more preferably at most 5 vol %, even more preferably at most 1 vol % based on the total volume of the gas mixture. Preferably, the gas mixture does not comprise a molecular-oxygen containing gas. The feed mixture may comprise carbon dioxide, preferably in an amount below 10 vol %.

The gaseous feed mixture has a temperature in the range of from 300 to 550° C. when it is supplied to the gas supply inlet of the tubes. Preferably, the feed mixture supplied to the gas supply inlet of the tubes has a temperature in the range of from 350 to 500° C., more preferably of from 400 to 480° C.

Typically, both the feedstock and the steam are pre-heated by heat exchange with the flue gas from the external heat source, usually a furnace or burner(s), to achieve the desired temperature. The gaseous feed mixture that is supplied to gas supply inlet of each tube has a temperature in the range of from 300 to 550° C.,

By flowing through the tortuous flow path provided by the insert, the feed mixture will be heated to a temperature of at least 600° C., preferably at least 650° C., more preferably at least 700° C. before it contacts the upstream end of the catalyst bed.

Preferably, the feed mixture has a temperature of at most 900° C. when contacting the upstream end of the fixed bed, more preferably at most 850° C., even more preferably at most 800° C. A temperature of the feed mixture in the range of from 600 to 800° C. when contacting the upstream end of the fixed bed is particularly preferred.

The steam reforming catalyst may be any steam reforming catalyst known in the art. Suitable examples of such catalysts are catalysts comprising a Group VIII metal supported on a ceramic or metal catalyst carrier, preferably supported Ni, Co, Pt, Pd, Ir, Ru and/or Ru, more preferably supported nickel or ruthenium. Nickel-based catalysts, i.e. catalysts comprising nickel as catalytically active metal, are commercially available.

As has been described hereinabove, the feed mixture is further heated in the insert to a temperature of at least 600° C., preferably at least 650° C., more preferably at least 700° C. The feed mixture then contacts the fixed bed of catalyst and is catalytically converted into synthesis gas. The catalyst bed is typically operated at a temperature in the range of from 600 to 1,050° C., preferably in the range of from 650 to 950° C., more preferably of from 700 to 850° C. Reference herein to the operating temperature is to the averaged catalyst bed temperature. Typically, the temperature at the downstream end of the catalyst bed is higher than the temperature at its upstream end.

The catalyst bed may be operated at any pressure suitable for steam reforming, preferably at a pressure in the range of from 1 to 40 bar (absolute), more preferably of from 10 to 30 bar (absolute). Preferably, the gas hourly space velocity (volumic flow rate of the feed mixture at standard temperature and pressure (STP: 0° C. and 1 atmosphere) per volume unit of catalyst bed) is in the range of from 1,000 to 10,000 h⁻¹, more preferably of from 2,000 to 7,000 h⁻¹.

In the process according to the invention, carbon deposition on the catalyst is minimised. Small quantities of carbon may, however, be formed on the insert by thermal cracking of the feedstock. Without wishing to be bound to any theory, it is believed that the coke formed on the insert is typically entrained by the feed mixture and subsequently converted into carbon monoxide in the catalyst bed by reaction with carbon dioxide (Boudouard reaction).

### DETAILED DESCRIPTION OF THE DRAWINGS

In each of FIGS. 1A to 1C is shown a schematic drawing of a longitudinal section of the upstream part of a steam reforming tube comprising an insert. In each of FIGS. 1A to 1C is shown the upstream part of steam reforming tube 1, having gas supply inlet 2 and containing catalyst bed 3 (partly shown) and insert 4 placed downstream of inlet 2 and upstream of catalyst bed 3. A stream of feed mixture 5 is supplied via inlet 2 to tube 1 and is forced to flow through insert 4 to catalyst bed 3. The feed mixture follows a tortuous flow path (dotted arrows) between upstream end 6 and downstream end 7 of insert 4 before it is supplied to catalyst bed 3.

In FIG. 1C, insert 4 defines a helical free fluid flow path.

### EXAMPLES

The invention is further illustrated by means of the following non-limiting examples.

### Example 1 (According to the Invention)

A gaseous feed mixture comprising steam and a hydrocarbonaceous feedstock with 67 wt % natural gas and 33 wtl % glycerol (the molar H₂O:C ratio in the feed mixture was 3.4) was supplied to a steam reformer tube having a length of 13 metres with a gas supply inlet at its upper end. The tube contained a catalyst bed with particles of a commercially available Ni-based steam reforming catalyst and a helically would Ni—Cr alloy insert with a length of 2.5 metres gas-tightly fitted into the tube just upstream of the catalyst bed. The catalyst bed had a length of 10.5 metres. The tube was externally heated by a burner. The steam reforming process was carried out at a pressure of 20 bar (gauge).

The temperature in the tube was measured with thermocouples placed in the central axis of the tube at several locations along its length.

### Example 2 (Comparison)

The experiment of EXAMPLE 1 was repeated, but now the steam reformer tube was entirely filled with catalyst particles, i.e. the catalyst bed was extending over a length of 13 metres. The temperature in the tube was measured in the same manner as in EXAMPLE 1.

In the Table is shown the temperature at different locations in the tube for EXAMPLES 1 and 2.

TABLE
Results of temperature measurements

| | |
|---|---|
| Distance from inlet | Temperature [° C.] |

| [m] | EXAMPLE 1 | EXAMPLE 2 |
|---|---|---|
| 0 | 498 | 498 |
| 2.5^{a} | 661 | 611 |
| 4.0 | 720 | 634 |
| 5.5 | 667 | 651 |
| 7.0 | 659 | 668 |
| 8.5 | 692 | 692 |
| 10.0 | 739 | 739 |
| 11.5 | 797 | 797 |
| 13.0 | 849 | 849 |

^{a}downstream end of insert and upstream end of catalyst bed in EXAMPLE 1.

It can be seen from the results of the temperature measurements that if an insert is placed upstream of the catalyst bed (EXAMPLE 1), a shorter catalyst bed is needed in order to achieve the same conversion (same temperature at the downstream end of the catalyst bed, i.e. at 13 metres). Moreover, the temperature of the feed mixture when entering the upstream end of the catalyst bed (at 2.5 metres in EXAMPLE 1 and at 0 metres in comparison EXAMPLE 2, is much higher when using an insert, thus minimising coke formation in the catalyst.

1-14. (canceled)

15. A multi-tubular steam reformer, comprising a steam reforming zone heated by an external heat source, which steam reforming zone comprises:
(a) a plurality of parallel steam reforming tubes, each tube comprising a gas supply inlet;
(b) a fixed bed of steam reforming catalyst; and
(c) a solid, inert insert having an upstream end and a downstream end which insert is placed in the steam reforming tubes downstream of the gas supply inlet and upstream of the catalyst bed,
wherein the insert defines a tortuous-free fluid flow path through the tubes between the upstream end and the downstream end of the insert,
wherein the catalyst bed has an upstream end and a downstream end, the upstream end of the catalyst bed being adjacent to the downstream end of the insert, and
wherein the ratio of the length of the insert and the length of the catalyst bed is between 0.05 to 0.5.

16. The multi-tubular steam reformer according to claim 15, wherein the ratio of the length of the insert and the length of the catalyst bed is between 0.1 to 0.3.

17. The multi-tubular steam reformer according to claim 15, wherein the tortuous free fluid flow path through the insert has an effective length at least two times the length of the insert.

18. The multi-tubular steam reformer according to claim 15, wherein the insert is a metal insert.

19. The multi-tubular steam reformer according to claim 15, wherein the tortuous-free fluid flow path is a helical-free fluid flow path.

20. A process for catalytic steam reforming of a hydrocarbonaceous feedstock comprising an oxygenated hydrocarbonaceous compound, the method comprising supplying a gaseous feed mixture comprising the hydrocarbonaceous feedstock and steam having a temperature between 300 to 550° C. to the gas supply inlet of each of the steam reforming tubes of a multi-tubular steam reformer according to claim 15, such that the feed mixture flows through the insert and subsequently contacts the upstream end of the catalyst bed at a temperature of at least 600° C.

21. The process according claim 20, wherein the feed mixture comprises at most 1 vol % of molecular oxygen.

22. The process according claim 20, wherein the feed mixture has a temperature of at least 650° C. when contacting the upstream end of the catalyst bed.

23. The process according to claim 20, wherein the oxygenated hydrocarbonaceous compound is glycerol.

24. The process according to claim 20, wherein the hydrocarbonaceous feedstock further comprises a hydrocarbon, wherein the weight ratio of hydrocarbon to oxygenated hydrocarbonaceous compound is between 1:1 to 3:1.

25. The process according to claim 24, wherein the hydrocarbon is natural gas, biogas or methane.

26. The process according to claim 20, wherein the feed mixture has a molar steam to carbon ratio between 2.0 to 5.0.

27. The process according to claim 20, wherein the steam reforming catalyst is a nickel-based catalyst.

28. The process according to claim 20, having a pressure drop over the insert of between 1 to 20% of the total pressure drop over the insert and the catalyst bed.
